(19) United States
(12) Patent Application Publication
(10) Pub. No.: US 2020/0098050 A1
(43) Pub. Date: Mar. 26, 2020

(54) Real Time Risk Pricing

(71) Applicant: Toby Unwin, Orlando, OH (US)

(72) Inventor: Toby Unwin, Orlando, OH (US)

(21) Appl. No.: 16/141,974

(22) Filed: Sep. 26, 2018

(51) Int. Cl. G06Q 40/08; G06N 5/02; G06Q 30/02

(52) U.S. Cl. CPC G06Q 40/08; G06Q 30/0283; G06N 5/022

(57) ABSTRACT

The invention is an artificial intelligence system that can produce real time risk pricing for insurance. The system will compile and analyze the most current litigation records and data and match those to specific lines of businesses per a given location. The system will use this information to generate real time risk pricing for underwriting purposes.

### CROSS-REFERENCES TO RELATED APPLICATIONS (IF ANY)

None

### BACKGROUND OF INVENTION

### Field of the Invention

The present invention is directed to a method of analyzing and quantifying Real Time Risk Pricing for insurance underwriting.

### Background

Insurance has traditionally been underwritten using historical, actuarial models. This normally works well and can be profitable. Litigation Risk changes constantly. However, when the numbers change, it gets very expensive.

There is still room for improvement in the art.

### SUMMARY OF THE INVENTION

The current invention is an artificial intelligence system that can produce real time risk pricing for insurance. The system will compile and analyze the most current litigation records and data and match those to specific lines of businesses per a given geographical location. The system will use this information to generate real time risk pricing for underwriting purposes.

Given the significant value of these types of risks the monies involved can be substantial.

### BRIEF DESCRIPTION OF THE DRAWINGS

Without restricting the full scope of this invention, the preferred form of this invention is illustrated in the following drawings:

FIG. 1 is a block diagram showing a basic arrangement of a computer system that can run the current invention;

FIG. 2 is a schematic block diagram of a conceptualized operation of the present invention.

FIG. 3 shows how risk can change over time based on location; and

FIG. 4 is an example of the system's offer versus the actual values.

### BRIEF DESCRIPTION OF THE PREFERRED EMBODIMENTS

There are a number of significant design features and improvements incorporated within the invention.

The current invention is a system 1, method and program product that uses current case history from court cases and settlement to compile and generate real time risk pricing for insurance underwriting.

The system 1, uses an artificial intelligence system that takes litigation results by area and line of business and compiles the results to produce a real time risk pricing.

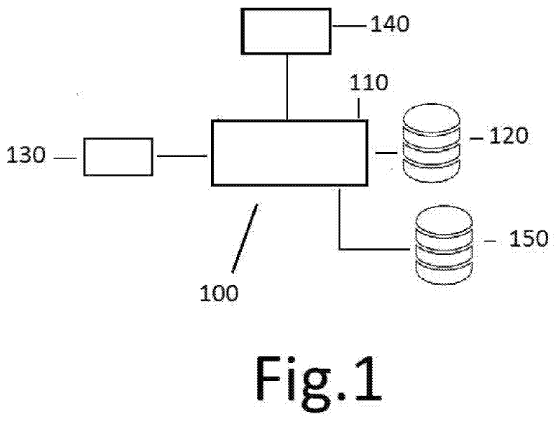

The system 1 can be set up to be run a on a computing device. FIG. 1 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here. The system 1, data, files and processing code can reside in the non-transitory memory of the one or more computing devices.

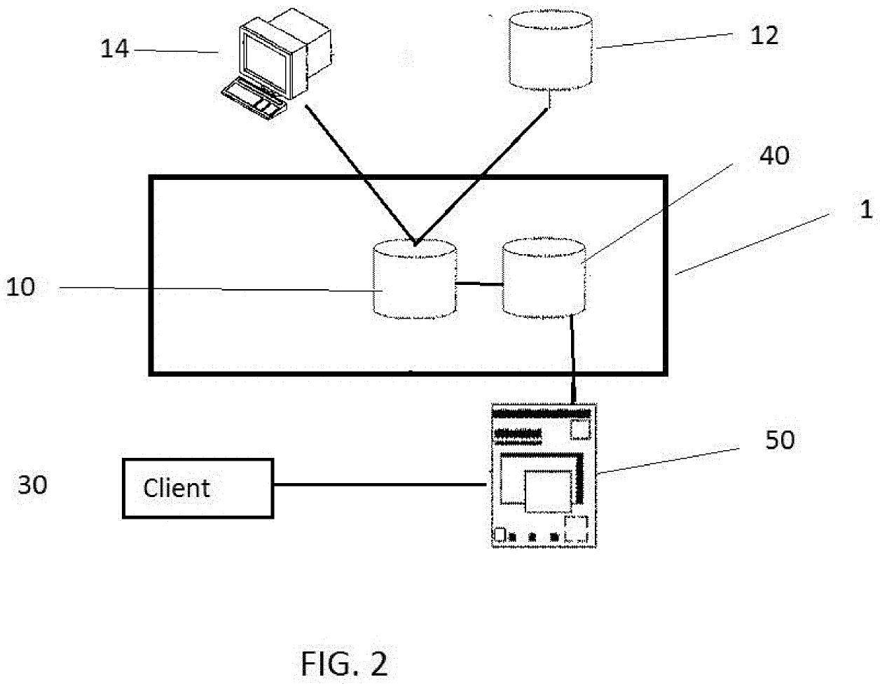

This system 1 is shown in FIG. 2, the System 1 will gather information 10 about court case results.

The information 10 about the results and findings can be gathered from court databases 12 or keyed into the system 1 by a keyboard entry 14 or any other method of entry. The information 10 will have data on everything relevant available that can be used to analysis the litigation results. This data would include but not limited to the location, results of the suit or the settlement received and the amount.

This data 40 can be specifically compiled and analyzed using a computer processing means.

The data 40 is loaded into electronic medium and is analyzed by the system 1 based on the desired criteria.

The system 1 uses a database that is updated in real time such as hourly. The case types are compiled and matched to Insurance Lines of Business and geographical location. The system 1 knows the errors and opportunities in underwriting assumptions in real time.

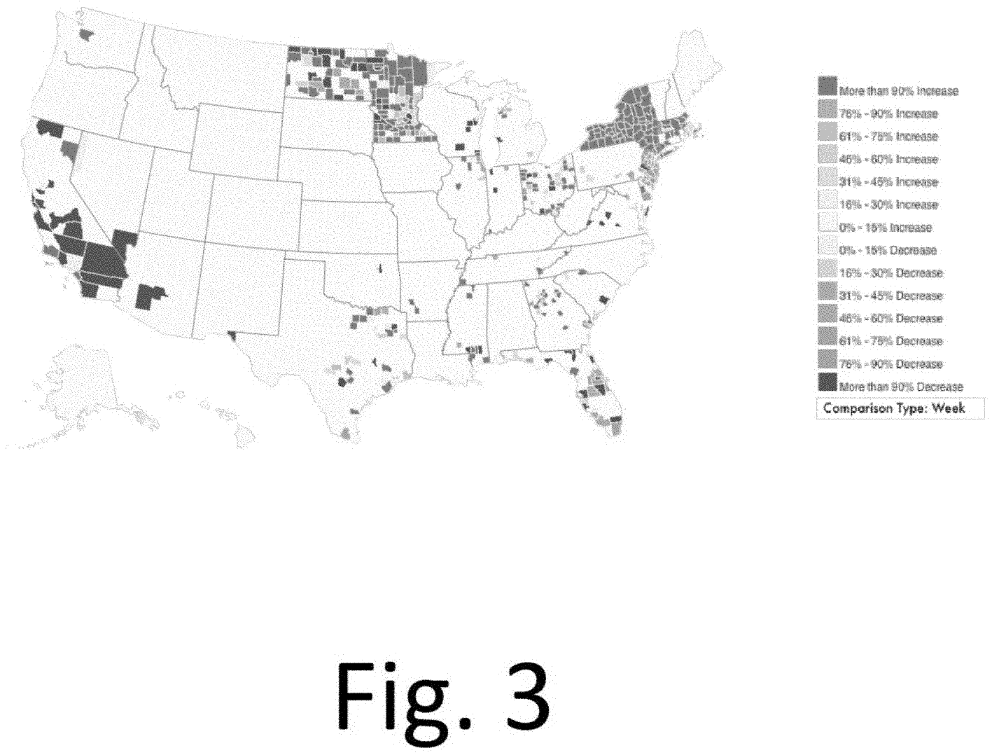

FIG. 3 shows how changes of risks change based on the location. How a real time analysis will show how the risk rates can go up or down.

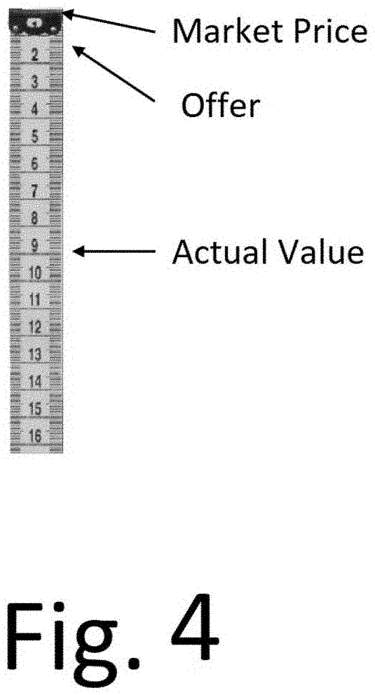

FIG. 4 shows the pricing of risk with the market price and actual value with an offer. The offer at the best available pricing for 10% of a portfolio. The 10% will be different from the part of the portfolio currently valued high the general market. This allows the offer first pick of risk placements. The system knows errors and opportunities in underwriting assumptions in real time.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

Advantages

The system allows real time vs historical underwriting.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method comprising the steps:
having a computing device, having data, files and processing code reside in the non-transitory memory of the computing device, having information about previous court cases, loading this information into a database, using this information to create data where said data is based on line of business and location using the data to create risk pricing for insurance, where said information is loaded in real time, and shows changes of risks change based on the location.

2. (canceled)

3. (canceled)

4. (canceled)
